(19) United States
(12) Patent Application Publication
(10) Pub. No.: US 2006/0224874 A1
(43) Pub. Date: Oct. 5, 2006

(54) Method for updating system management basic input output system (SMBIOS) data

(75) Inventors: Ying-Chih Lu, Taipei (TW); Chun-Lung Wu, Taipei (TW); Chun-Yi Lee, Taipei (TW); Lung-Hung Yu, Taipei (TW); Chi-Tsung Chang, Taipei (TW); Meng-Hua Cheng, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/095,782

(22) Filed: Mar. 30, 2005

(51) Int. Cl. G06F 9/445

(52) U.S. Cl. 713/1

(57) ABSTRACT

A method for updating System Management Basic Input Output System (SMBIOS) data in BIOS of a computer system is provided so as to allow a user to store user-defined information in a storage unit of a computer system, wherein the storage unit has a default SMBIOS data. This method establishes an accessing block in the BIOS that enable the user to access user data, determines whether the accessing block contains the user data after activating the BIOS. If there is user data in the accessing block, the user data is stored in the storage unit and the default SMBIOS data is removed; otherwise, the default SMBIOS data is retained, thereby achieving the advantage of easy update.

### FIELD OF THE INVENTION

The present invention relates to a method for updating data, and more particularly, to a method for updating data at a storage block of a System Management Basic Input Output System (SMBIOS) in a Basic Input Output System (BIOS).

### BACKGROUND OF THE INVENTION

Basic Input Output System (BIOS) is the most fundamental software for basic operations of computer among computer architectures nowadays. BIOS is mainly comprised by low-level instruction sets, which provides the most basic hardware testing, computer characteristics defining and basic tasks handling when computer operates. For example, when the computer is turned on, a Power-on Self-Test (POST) of computer is implemented, which initializes all electronic devices on the computer, interprets messages from a keyboard and passes information between connection ports, etc. Therefore, the initialization performed when the computer is turned on is implemented in accordance with contents of the BIOS. If problems occur in the BIOS when the computer is turned on, where electronic components such as Random Access Memory (RAM), Hard Drive (HD) and Central Processing Unit (CPU) cannot be tested, an unsuccessful Power-On is resulted. Since the BIOS plays an important role in a computer system, most system producers write the BIOS program instruction set into a memory that allows permanent data storage for a long time, for example, a flash read-only memory (flash ROM), a programmable read-only memory (PROM), an erasable programmable read-only memory (EPROM) and electrically erasable programmable read-only memory (EEPROM), etc. This BIOS memory is sometimes built into the motherboard or a chipset in the computer system. Therefore, contents are not affected by the power supply and can be kept permanently.

However, the contents of the BIOS memory are not necessarily fixed, for instance, when a computer system manufacturer produces a faulty BIOS or when the system manufacturer changes a computer model that requires update according to user's need. In these situations, data most likely requires update is the so-called System Management Basic Input Output System (SMBIOS) data in the BIOS memory, which is an important and essential data in BIOS. The SMBIOS data records all sorts of information related to the c computer system in which the SMBIOS is stored, especially a Type 1 information (system or manufacturer information), a Type 2 information (base board information), and a Type 3 information (system enclosure or chassis information). Also, each individual system motherboard has its unique system information, for instance, a unique motherboard sequence number. Therefore, the SMBIOS requires frequent and massive update.

Although some manufacturers have provided equipments for updating, these equipments are designed for directly writing over the information originally stored in the BIOS memory. If users update with incorrect data or wish to restore the previous data, the whole system would need to be flash again. It is inconvenient and not meeting the requirements needed by the efficient society nowadays. Moreover, there are many problems that still exist in carrying out the update by those tools, these problems including: when BIOS update is affected by an unpredictable operation (e.g. power failure during update), the data contents (e.g. SMBIOS data) may be lost or generate an error, causing errors in executing the BIOS when the computer is just turned-on, such that the computer cannot be completely turned on. Moreover, if the user (e.g. system manufacturer) wants to update massive amount of SMBIOS data, one-by-one updating is required to successfully proceed to testing or product releasing at a later stage. This really consumes a lot of manufacturer's time and cost.

From the foregoing problems, the conventional method of updating SMBIOS data still has many problems waiting to be solved.

### SUMMARY OF THE INVENTION

In view of the aforementioned technical problems, a main objective of the present invention is to provide a method for updating system management basic input output system (SMBIOS) data of a computer to prevent boot failure of the computer when power is cut off during the updating process of the SMBIOS.

Another objective of this invention is to provide a method for updating SMBIOS data to avoid wasting excessive time and cost when updating massive data.

In accordance with the above and other objectives, the present invention proposes a method for updating SMBIOS data of BIOS in a computer system comprising the steps of: establishing an accessing block by the BIOS, which allows a user to access user data from the block; activating the system and determining whether the accessing block contains a user data or not, if there is data in the accessing block, then storing the user data in a storage unit of computer system and removing the original default SMBIOS data stored in the storage unit. On the other hand, if it is determined that no user data exists in the accessing block, keeping the default SMBIOS data in the storage unit; then ending the system power on procedure.

Compared to the conventional updating equipments provided by the manufactures, the present invention provides an accessing block that allows a user to access user data and an automatic determining method to update data without damaging the SMBIOS data original stored in the BIOS, achieving the foregoing main and other objectives.

### BRIEF DESCRIPTION OF THE DRAWINGS

The present invention can be more fully understood by reading the following detailed description of the accompanying drawings, wherein:

FIG. 1 is a flowchart showing a method for updating data in a System Management Basic Input Output System.

### DETAILED DESCRIPTION OF THE PREFERED EMBODIMENTS

The other advantages and efficiencies of the present invention can be more fully understood by reading the following detailed description of the preferred embodiments, the present invention also can be preformed and applied using other different preferred embodiments, and the details of the description can be based on different perspectives and applications to have different modifications and arrangements but still within the scope of the present invention.

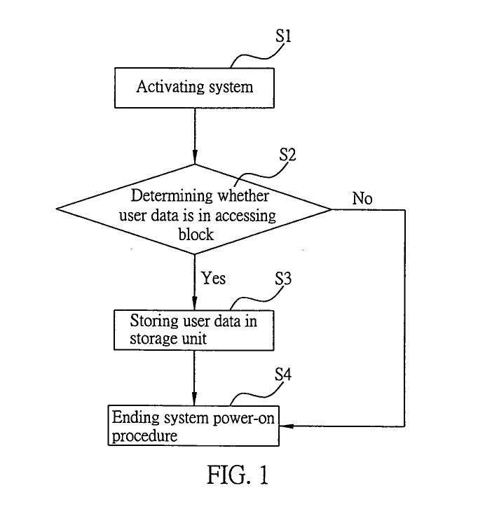

FIG. 1 is a flowchart showing the operation of the present invention. The method for updating data in the System Management Basic Input Output System (SMBIOS) of the present invention will be described by the following detailed description in conjunction with the accompanying drawing. It should be noted that the diagram is a simplified flowchart and only explain the basic steps in the procedures that are of relevance to the present invention.

FIG. 1 shows a simplified flowchart illustrating operations of a computer system for implementing the method of updating data in SMBIOS according to the present invention. This method allows user to store updating data in a storage unit of the computer system to replace the default data stored in the storage unit of SMBIOS as needed. The foregoing storage unit is a memory in the computer system, such as a Double Data-Rate Synchronous DRAM (DDR) or a Synchronous DRAM (SDRAM) etc. The method of the present invention can be applied to computer system including laptops, desktops, servers, and workstations (not illustrated here). Before carrying out this method, an accessing block is provided in the BIOS of the computer system. Specifically, the accessing block that allows the user to access user data to be used for updating is found by firstly searching through a flash ROM of the BIOS. The user data will be Type 1, Type 2 and Type 3 data essential to the SMBIOS, whereas Type 1 data generally is system information or manufacturer information, Type 2 data generally is base board information, and Type 3 data is generally system enclosure or chassis information. The foregoing accessing block is at a protected status, which means data in the accessing block cannot be deleted or modified by a “flash” or other methods via the BIOS except by user.

This method begins with step S1, activating the system. Computer systems are turned on at this step, and the BIOS proceed to the Power-On Self-Test stage, which is a routine procedure carried out when a standard computer system is activated, thus no further detail is given. At this step, the computer system will store the default SMBIOS data from a SMBIOS storage block of the BIOS (this storage block is for example located in the flash ROM of the BIOS) to a storage unit of the computer system. This action is also a routine procedure performed by the standard computer system after turned on. Then moving on to step S2.

In step S2, determining whether user data exist in the accessing block. In this step, the computer system determines whether there is user data in the accessing block. Specifically, determining whether there is user data in the accessing block of the BIOS to be used for updating, if there is, proceeding to step S3, otherwise, proceeding to step S4.

In step S3, storing the user data. In this step, the computer system store the user data by removing the default SMBIOS data in the foregoing storage unit of the computer system and storing the user (updating) data from the foregoing accessing block in this storage unit, then data update desired by the user is completed. If the user made a mistake in his updating data or wishes to recover the default system status before update, (i.e. when the user wishes to store the default SMBIOS data in the storage unit of the computer system), it is fulfilled by simply removing the user data from the accessing block. Hence, next time the computer system is turned on, the computer system will detect no user data in the accessing block and the default SMBIOS data stored will remain in the storage unit. Then proceeding to step S4.

In step S4, terminating the Power-On procedure of system. In this step, the computer system terminates the Power-On procedures, i.e. the POST of the BIOS and then enters into the operation system (OS).

From the illustrations of the foregoing descriptions and diagram, the technical characters and specific implementation of the present invention can be well understood, that is, providing an accessing block that allows user to access user data in the BIOS, then after the activation of the computer system, determining whether there is a user data in the accessing block, if the user data exists, then the user data is stored in storage unit of the computer system and also the default SMBIOS data is removed from the storage unit, otherwise, the default SMBIOS data is kept in the storage unit, hence, achieving system data update (especially Type 1, Type 2 and Type 3 SMBIOS data) described in the present invention. Therefore, in light of the above method, it is obvious that the present invention provides the advantage of easy update; and if power is cut off during the update process, the risk of causing damages to the BIOS memory as described in the prior art will be prevented, since the computer system will automatically store the default SMBIOS data in the storage unit of the computer system to restore the system back to the status before the update for normal booting process when the system is restarted. Moreover, when updating massive system data, the update is completed by simply storing the user data to be used for update in the accessing block, then reactivating the system, so that the computer system can be tested or released at the later process stage, without having to run through the time- and cost-consuming update process for the entire BIOS.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for updating System Management Basic Input Output System (SMBIOS) data in a Basic Input Output System (BIOS), a storage unit of the computer system being used to store the SMBIOS data, wherein a default SMBIOS data is stored in default but a user is allowed to store a user data in the storage unit as needed, and the SMBIOS data being used in a Power-On Self-Test (POST) procedure or an operating system of the computer system, the method comprising:
(1) establishing an accessing block in a BIOS that allows a user to access the user data;
(2) causing the BIOS to activate and carry out the POST procedure;
(3) causing the BIOS to determine whether there is a user data in the accessing block, if so, proceeding to step (4); otherwise, proceeding to step (5);
(4) causing the BIOS to remove the default SMBIOS data from the storage unit, and to store the user data in the storage unit, then going to step 5;
(5) causing the BIOS to terminate the POST procedure.

2. The method for updating SMBIOS data of claim 1, wherein the user data is at least one selected from the group consisting of Type 1, Type 2 and Type 3 SMBIOS data.

3. The method for updating SMBIOS data of claim 2, wherein the Type 1 SMBIOS data is at least one of a system information and a manufacturer information.

4. The method for updating SMBIOS data of claim 2, wherein the Type 2 SMBIOS data is a base board information.

5. The method for updating SMBIOS data of claim 2, wherein the Type 3 SMBIOS data is at least one of a system enclosure and a chassis information.

6. The method for updating SMBIOS data of claim 1, wherein the accessing block is located in flash Read Only Memory (flash ROM) of the BIOS.

7. The method for updating SMBIOS data of claim 1 or 6, wherein the accessing block is at a protected status to avoid deleting data in the accessing block by using flash method via the BIOS.

8. The method for updating SMBIOS data of claim 1, wherein the default SMBIOS data is stored in a storage block of the SMBIOS of the BIOS, and after the activation of the BIOS, the computer system stores the default SMBIOS data in the storage unit.

9. The method for updating SMBIOS data of claim 8, wherein the storage block of the SMBIOS is located in the flash Read Only Memory (flash ROM) of the BIOS.

10. The method for updating SMBIOS data of claim 1, wherein the storage unit is a memory of the computer system.

11. The method for updating SMBIOS data of claim 1, 8 or 10, wherein the storage unit is one of Double Data-Rate Synchronous Dynamic Random Access Memory (DDR DRAM) and Synchronous DRAM (SDRAM).
